(19) United States
(12) Patent Application Publication
(10) Pub. No.: US 2002/0137465 A1
(43) Pub. Date: Sep. 26, 2002

(54) Information processing apparatus and clock control method

(76) Inventor: Masanori Nakano, Ome-shi (JP)

Correspondence Address: PILLSBURY WINTHROP, LLP, P.O. BOX 10500, MCLEAN, VA, 22102, US

(21) Appl. No.: 10/095,576

(22) Filed: Mar. 13, 2002

(30) Foreign Application Priority Data
Mar. 23, 2001 (JP) 2001-085814

(51) Int. Cl. H04B 15/00

(52) U.S. Cl. 455/62; 455/63

(57) ABSTRACT

An information processing apparatus, comprises a wireless communication unit, a frequency circuit which generates a plurality of frequencies that are not constant multiples to each other and serve as operation frequencies, a communication quality determination unit which determines whether a communication quality of the wireless communication unit has become lower than a predetermined level, and a selection unit which selects a frequency different from a current frequency from the plurality of frequencies generated by the frequency circuit when the communication quality determination unit determines that the communication quality has become lower than the predetermined level.

### CROSS-REFERENCE TO RELATED APPLICATIONS

This application is based upon and claims the benefit of priority from the prior Japanese Patent Application No. 2001-085814, filed Mar. 23, 2001, the entire contents of which are incorporated herein by reference.

### BACKGROUND OF THE INVENTION

1. Field of the Invention

The present invention relates to an information processing apparatus on which a wireless module is mounted to perform wireless communication, and a clock control method used in the information processing apparatus.

2. Description of the Related Art

In general, when wireless communication is performed in an information processing apparatus for performing wireless communication, noise increases at a specific wireless frequency which interferes with the operation clock used in a circuit other than the wireless unit, obstructing wireless communication. Hence, the frequency of the operation clock used in a circuit other than the wireless unit must be so designed as not to interfere with the wireless frequency.

However, for a wireless band widened to a certain degree, the operation clock of a circuit other than the wireless unit is difficult to design so as not to interfere with the entire wireless band.

Even if the frequency of the operation clock is changed during the operation of the information processing apparatus, a change of simply multiplying or dividing the clock frequency by a constant cannot reduce noise generated when the operation clock used in a circuit other than the wireless unit interferes with the wireless frequency to pose a problem in wireless communication.

A technique of changing the clock during the operation of an apparatus is disclosed in, e.g., Japanese Patent Application No. 11-38885. The technique disclosed in Japanese Patent Application No. 11-38885 is a CPU clock control method of controlling the CPU clock in order to reduce EMI (Electromagnetic Interference) and decreasing the clock stepwise (constant multiplication/division) in accordance with the number of interrupt requests.

In the prior art, it is difficult to design the operation clock used in a circuit other than the wireless unit so as to prevent the operation clock used in a circuit other than the wireless unit from interfering with the wireless frequency. For example, in the use of the technique disclosed in Japanese Patent Application No. 11-38885, even if the operation clock is changed during the operation of the apparatus, a change using constant multiplication/division cannot reduce noise generated when the operation clock used in a circuit other than the wireless unit interferes with the wireless frequency to pose a problem in wireless communication.

### BRIEF SUMMARY OF THE INVENTION

It is an object of the present invention to provide an information processing apparatus and clock control method capable of reducing noise in wireless communication by changing the frequency of the operation clock so as not to interfere with the wireless frequency band of a wireless module used for wireless communication.

According to a first aspect of the invention, there is provided an information processing apparatus, comprising: a wireless communication unit; a frequency circuit which generates a plurality of frequencies that are not constant multiples to each other and serve as operation frequencies; a communication quality determination unit which determines whether a communication quality of the wireless communication unit has become lower than a predetermined level; and a selection unit which selects a frequency different from a current frequency from the plurality of frequencies generated by the frequency circuit when the communication quality determination unit determines that the communication quality has become lower than the predetermined level.

In the information processing apparatus, the frequency circuit includes a plurality of clock oscillators which generate the plurality of frequencies to operate at predetermined clocks, and the selection unit selects the clock oscillator from the plurality of clock oscillators.

According to a second aspect of the invention, there is provided an information processing apparatus, comprising: a wireless communication unit: a frequency circuit which generates a plurality of frequencies that are not constant multiples of each other and serve as operation frequencies; a determination unit which determines whether a wireless communication execution request exists; a frequency determination unit which determines a wireless frequency to be used for the wireless communication unit when the determination unit determines that the wireless communication execution request exists; an interference determination unit which determines whether a current operation frequency interferes with the wireless frequency determined by the frequency determination unit; and a selection unit which selects a frequency which does not cause interference from the plurality of frequencies generated by the frequency circuit when the interference determination unit determines that the current operation frequency interferes with the wireless frequency

In the information processing apparatus, the frequency circuit includes a plurality of clock oscillators which generate the plurality of frequencies to operate at predetermined clocks, and the selection unit selects the clock oscillator from the plurality of clock oscillators.

According to a third aspect of the invention, there is provided a clock control method for an information processing apparatus which performs wireless communication, comprising: communication quality determining whether communication quality in wireless communication has become lower than a predetermined level; selecting a frequency different from a current frequency from a frequency circuit which generates a plurality of frequencies that are not constant multiples of each other and serve as operation frequencies of the apparatus when the communication quality is determined in the communication quality determining to have become lower than the predetermined level; and operating the apparatus on the basis of the frequency selected in the selecting a frequency.

According to a fourth aspect of the invention, there is provided a clock control method for an information processing apparatus which performs wireless communication, comprising: determining whether a wireless communication execution request exists; determining a wireless frequency used for wireless communication when presence of the wireless communication execution request is determined in the determining; determining whether a current operation frequency of the apparatus interferes with the wireless frequency determined in the determining a wireless frequency; and when the current operation frequency interferes with the wireless frequency, selecting a frequency of the clock which does not interfere with the wireless frequency determined in the determining a wireless frequency.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the main arrangement of an information processing apparatus according to the first embodiment of the present invention;

FIG. 2 is a view showing interference between the frequency of a wireless communication unit 18 and frequencies generated by clock oscillators A1 and A2;

FIG. 3 is a flow chart for explaining clock control operation in the first embodiment;

FIG. 4 is a timing chart concerning the CPU clock in changing the operation clock;

FIG. 5 is a flow chart showing clock control operation of controlling a frequency circuit 14 so as to attain a CPU clock for a specific purpose;

FIG. 6 is a flow chart for explaining clock control operation in the second embodiment;

FIG. 7 is a flow chart for explaining clock control operation in the third embodiment;

FIG. 8 is a block diagram showing the main arrangement of an information processing apparatus according to the fourth embodiment of the present invention; and

FIG. 9 is a block diagram showing the main arrangement of an information processing apparatus according to the fifth embodiment of the present invention.

### DETAILED DESCRIPTION OF THE INVENTION

Preferred embodiments of the present invention will be described below with reference to the several views of the accompanying drawing.

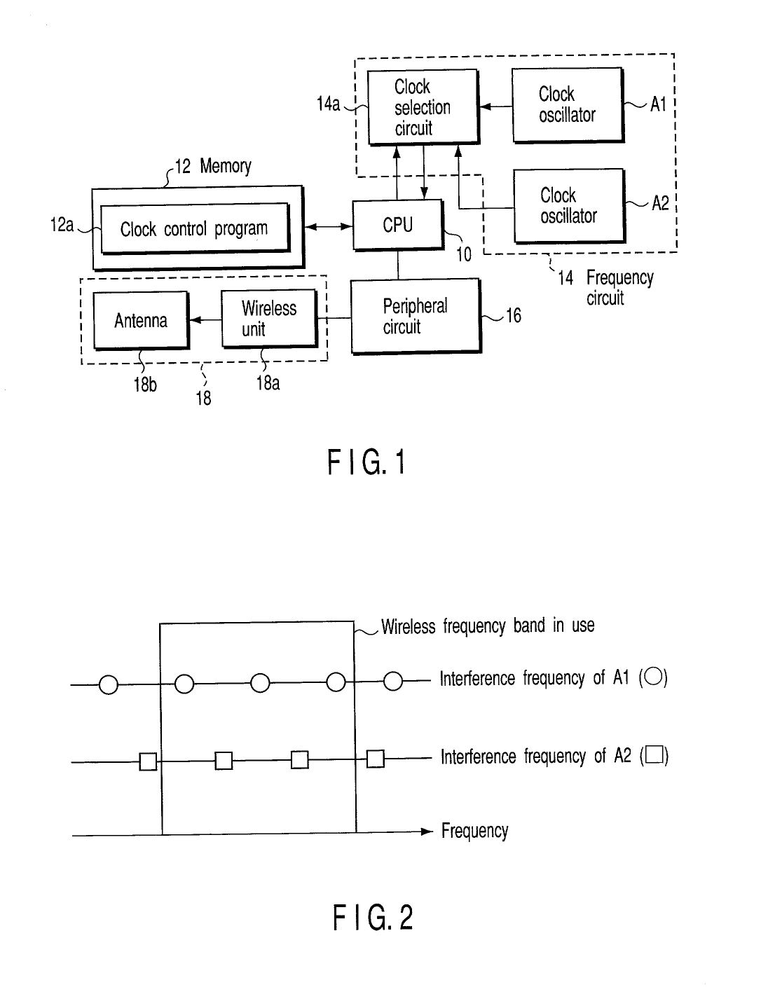

FIG. 1 is a block diagram showing the main arrangement of an information processing apparatus according to the first to third embodiments of the present invention. The information processing apparatus is implemented by a computer which loads a program recorded on a recording medium such as a CD-ROM, DVD, or magnetic disk, and the operation of the apparatus is controlled by the program.

As shown in FIG. 1, the information processing apparatus in the first to third embodiments comprises a CPU 10, memory 12, frequency circuit 14, and peripheral circuit 16. When the information processing apparatus is to perform wireless communication, a wireless communication unit 18 (wireless unit 18a and antenna 18b) having a wireless communication function is connected to the information processing apparatus via a cable or the like. The wireless communication unit 18 may be mounted as part of the information processing apparatus.

The CPU 10 controls the overall apparatus by executing a program stored in the memory 12. The CPU 10 executes a clock control program 12a stored in the memory 12. This realizes clock control which prevents interference between the frequency of the operation clock and the wireless frequency of the wireless communication unit 18 connected to achieve wireless communication. In clock control, a frequency band used for wireless communication in the wireless communication unit 18 connected to perform wireless communication is determined. Further, a frequency which does not interfere with the determined frequency band is selected from a plurality of frequencies generated by the frequency circuit 14.

The memory 12 stores various programs and data. As for clock control, the memory 12 stores the clock control program 12a.

The frequency circuit 14 generates a plurality of frequencies which are used as operation frequencies of the apparatus and are not constant multiples of each other. In the first to third embodiments, the frequency circuit 14 includes two oscillators, i.e., a clock oscillator Al which generates at a frequency f1 and a clock oscillator A2 which generates at a frequency f2, and a clock selection circuit 14a for selecting either clock oscillator A1 or A2 under the control of the CPU 10. Since frequencies f1 and f2 are not constant multiples of each other, a constant multiple of a frequency generated by one clock oscillator does not coincide with a frequency (including constant-multiplied/divided frequencies) generated by the other. If an interference frequency is generated even in an operation based on a frequency generated by either clock oscillator A1 or A2 in the wireless frequency band used by the wireless communication unit 18, a clock oscillator A3 which generates a frequency f3 different from frequencies f1 and f2 is newly added to obtain a frequency which does not interfere with the wireless frequency band used by the wireless communication unit 18.

The peripheral circuit 16 represents various units which constitute the information processing apparatus and include a unit to be connected to the wireless communication unit 18 for performing wireless communication. The peripheral circuit 16 interfaces with the wireless communication unit 18.

Examples of the wireless communication unit 18 are a PHS (Personal Handyphone System) terminal, a portable telephone, and a unit which realizes various forms of wireless communication such as Bluetooth.

The wireless frequency band used for wireless communication by the wireless communication unit 18 is, e.g., 800 MHz (base station transmission frequency: 810 to 826 MHz) or 1.5 GHz (base station transmission frequency: 1477 to 1501 MHz) for the portable telephone (PDC [Personal Digital Cellular]), 1.9 GHz (1893.5 to 1919.6 MHz) for the PHS, or 2.4 GHz (2400 to 2483.5 MHz in Japan) for Bluetooth.

FIG. 2 shows interference between the frequency of the wireless communication unit 18 and frequencies generated by clock oscillators A1 and A2. When the wireless frequency band used by the wireless communication unit 18 falls within the range represented by the rectangular frame in FIG. 2, interference occurs between the wireless frequency band and specific orders of harmonics of frequencies f1 and f2 of clock oscillators A1 and A2 (frequencies ◯ and □ included in the wireless frequency band of the wireless communication unit 18). In this case, clock oscillators A1 and A2 are designed such that either clock oscillator A1 or A2 generates the frequency f1 or f2 which does not interfere with the entire wireless frequency band of the wireless communication unit 18. That is, clock oscillators A1 and A2 are designed such that at least one of clock oscillators A1 and A2 generates the frequency f1 or f2 which does not cause interference regardless of the wireless frequency actually used for wireless communication in the wireless frequency band of the wireless communication unit 18.

An example of avoiding interference using two clock oscillators A1 and A2 will be explained.

Assume that the CPU 10 operates at a basic frequency of 22 MHz when the wireless communication unit 18 using a 1.5-GHz band (base station transmission frequency: 1477 to 1501 MHz) is connected. In this case, the 68th harmonic of 22 MHz is 1496 MHz. If the wireless communication unit 18 uses this frequency in wireless communication, interference occurs to degrade the communication performance. To prevent this, 21 MHz is used as a basic frequency of the operation clock of the CPU 10 in addition to 22 MHz. The basic frequency of the CPU 10 can be changed to 21 MHz to avoid interference in use of 1496 MHz in wireless communication.

The clock control operation of the information processing apparatus according to the first embodiment will be described.

To achieve operation for a specific purpose, the CPU 10 controls the clock selection circuit 14a to select either clock oscillator A1 or A2. The CPU 10 receives as an operation clock frequency f1 from clock oscillator A1 or frequency f2 from clock oscillator A2. At this time, the clock selection circuit 14a stops the operation of the unselected clock oscillator. Basically, the operation clock is so selected as to perform high-speed operation. For low-speed operation in order to reduce power consumption, the CPU 10 controls the frequency circuit 14 so as to attain an operation clock for a specific purpose.

When the wireless frequency used by the wireless communication unit 18 interferes with the frequency of the operation clock used on the apparatus side, the CPU 10 changes the normal operation frequency to an operation frequency which does not cause interference in wireless communication. After the end of wireless communication, the CPU 10 changes the operation frequency to the original one.

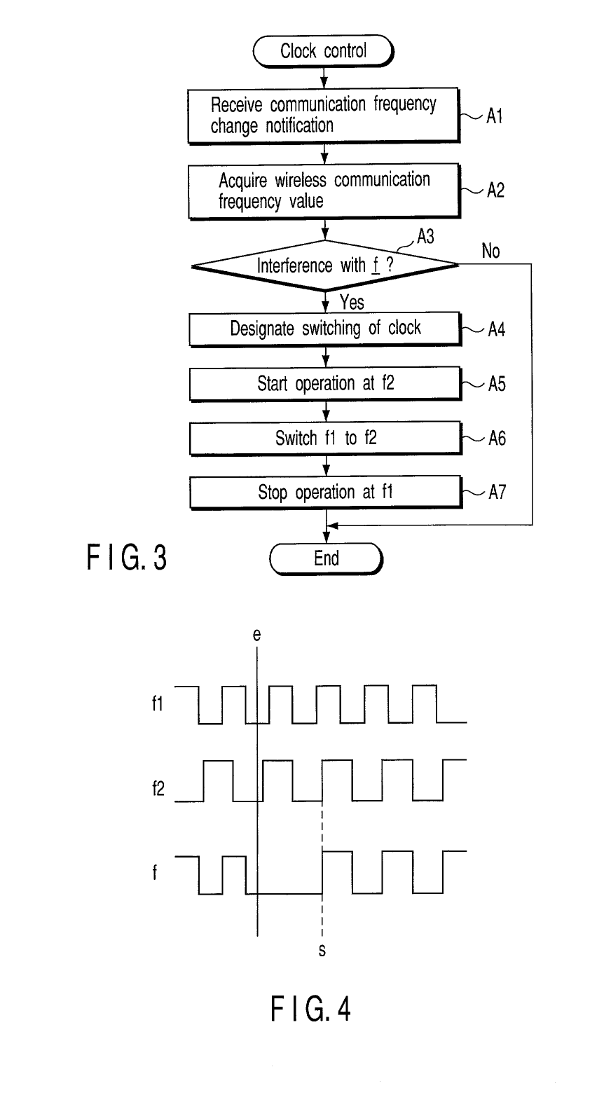

Operation to be performed when the wireless communication unit 18 for performing wireless communication in the wireless frequency band as shown in FIG. 2 is connected will be described with reference to the flow chart shown in FIG. 3. The CPU 10 executes the clock control program 12a stored in the memory 12 to realize clock control shown in the flow chart of FIG. 3.

In this case, interference with the wireless frequency band used by the wireless communication unit 18 is determined when the frequency of the operation clock of the CPU 10 is frequency f1 of clock oscillator A1.

The wireless communication unit 18 (wireless unit 18a) connected to the information processing apparatus determines based on a wireless communication start instruction from the CPU 10 a wireless frequency to be used for wireless communication in establishing a wireless communication channel with a base station or another device serving as a communication partner. The wireless communication unit 18 changes the wireless frequency to be used in accordance with the status.

If the CPU 10 receives a wireless communication change notification by a communication function realized by a program which controls the wireless unit 18a to perform communication operation (step A1), the CPU 10 acquires by this communication function the wireless frequency value currently used for wireless communication and the wireless frequency value to be changed (step A2).

The CPU 10 checks whether the frequency f of the current operation clock (in this case, frequency f1 of clock oscillator A1) interferes with the wireless frequency of the wireless unit 18a (step A3). The CPU 10 determines that the frequency f interferes with the wireless frequency of the wireless unit 18a when the wireless frequency of the wireless unit 18a is a constant multiple of frequency f1 or around a constant multiple.

If the CPU 10 determines that frequency f1 does not interfere with the wireless frequency of the wireless unit 18a, it continues normal operation without instructing the clock selection circuit 14a to change the clock oscillator.

If the CPU 10 determines that frequency f1 interferes with the wireless frequency of the wireless unit 18a (Yes in step A3), it instructs the clock selection circuit 14a to change the clock oscillator (step A4). The CPU 10 causes the clock selection circuit 14a to select clock oscillator A2 (steps A5 to A7). The clock selection circuit 14a which has received the instruction from the CPU 10 starts the operation of clock oscillator A2 at rest. The circuit 14a changes the frequency of a clock to be output to the CPU 10 from frequency f1 of clock oscillator A1 to frequency f2 of clock oscillator A2. Then, the circuit 14a stops the operation of clock oscillator A1.

In this manner, when the operation clock at frequency f1 of clock oscillator A1 interferes with the wireless frequency used by the wireless unit 18a, clock oscillator A1 is switched to clock oscillator A2 whose frequency f2 is so designed as not to interfere with the wireless frequency equal to frequency f1 of clock oscillator A1. Then, the CPU 10 operates at the operation clock having frequency f2. This control can avoid generation of noise which degrades the communication quality during wireless communication.

In the above description, the operation clock of the CPU 10 is changed by the frequency circuit 14. The operation clock of another unit (peripheral circuit 16) of the information processing apparatus other than the CPU 10 is also changed.

FIG. 4 is a timing chart concerning the CPU clock in changing the operation clock. In FIG. 4, f1 represents the clock waveform of clock oscillator A1; f2, the clock waveform of clock oscillator A2; and f, the waveform of a selected CPU clock. FIG. 4 shows a case wherein f1 selected as an operation clock is changed to f2. In FIG. 4, e represents the timing at which the CPU 10 sends a clock change instruction to the clock selection circuit 14a. In changing f from f1 to f2, in order to prevent a pulse glitch, the clock selection circuit 14a holds the f value at time e for one clock counted from the first rise of f2 from e (until time S in FIG. 4), then changes the f1 clock to the f2 clock, and supplies the f2 clock to the CPU 10. This enables stably supplying a clock to the CPU 10, and realizing clock change which does not cause any malfunction.

The timing chart of changing the operation clock in FIG. 4 is also applied to embodiments (second to fifth embodiments) (to be described later).

In the description of the first embodiment, when the frequency f of the operation clock is determined to interfere with the wireless frequency of the wireless unit 18a, the clock selection circuit 14a switches the clock oscillator to change the operation frequency. As for an operation clock used by a unit other than the wireless communication unit 18, if wireless communication is not executed, the information processing apparatus may be operated at an operation clock having a frequency for a predetermined purpose such that the CPU 10 is operated at high speed or changed to a power saving operation mode.

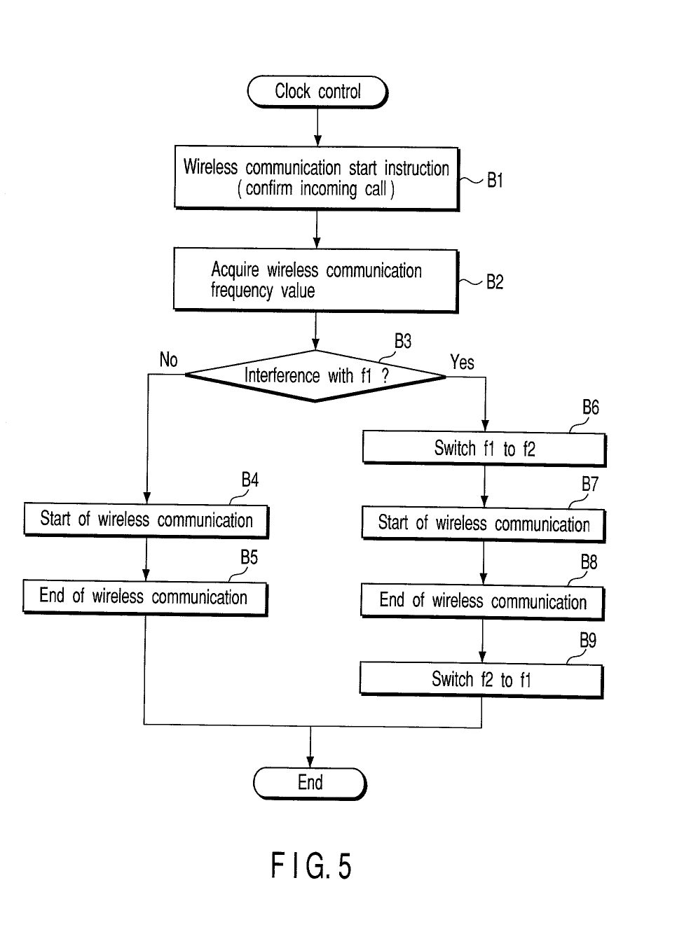

FIG. 5 is a flow chart showing clock control of controlling the frequency circuit 14 so as to attain a CPU clock for a specific purpose.

FIG. 5 exemplifies a case wherein interference with the wireless frequency used by the wireless communication unit 18 is determined when the CPU 10 operates at the operation clock having frequency f1 of clock oscillator A1 (normal operation) in order to operate the CPU 10 at high speed.

If the CPU 10 executes a wireless communication start instruction during normal operation, i.e., wireless communication using the wireless communication unit 18 starts (step B1), the CPU 10 acquires a wireless frequency value currently used for wireless communication by a communication function realized by a program which controls the wireless unit 18a to execute communication operation (step B2).

The CPU 10 checks whether frequency f1 of clock oscillator A1 in operation interferes with the wireless frequency band used by the wireless unit 18a (step B3). The CPU 10 determines that frequency f1 interferes with the wireless frequency when the wireless frequency of the wireless unit 18a is a constant multiple of frequency f1 or around a constant multiple.

If the CPU 10 determines that frequency f1 does not interfere with the wireless frequency of the wireless unit 18a, it starts wireless communication without instructing the clock selection circuit 14a to change the clock oscillator (step B4). The CPU 10 does not change the operation clock until wireless communication ends (step B5).

If the CPU 10 determines that frequency f1 interferes with the wireless frequency of the wireless unit 18a (Yes in step B3), it instructs the clock selection circuit 14a to change the clock oscillator immediately before the start of communication operation. The CPU 10 causes the clock selection circuit 14a to select clock oscillator A2 (step B6). The clock selection circuit 14a which has received the instruction from the CPU 10 starts the operation of clock oscillator A2 at rest. The circuit 14a changes the frequency of a clock to be output to the CPU 10 from frequency f1 of clock oscillator A1 to frequency f2 of clock oscillator A2. Then, the circuit 14a stops the operation of the clock oscillator A1.

After the clock selection circuit 14a changes the frequency of the operation clock, the CPU 10 starts wireless communication (step B7). The operation clock is kept at frequency f2 from clock oscillator A2 until the end of wireless communication (step B8).

After wireless communication operation ends, the CPU 10 changes the frequency of the operation clock by the same procedure as that at the start of communication. More specifically, the CPU 10 instructs the clock selection circuit 14a to change the clock oscillator, and causes the clock selection circuit 14a to select clock oscillator A1 (step B9). The clock selection circuit 14a which has received the instruction from the CPU 10 starts the operation of clock oscillator A1 at rest. The circuit 14 changes the frequency of a clock to be output to the CPU 10 from frequency f2 of clock oscillator A2 to frequency f1 of clock oscillator A1. Then, the circuit 14a stops the operation of the clock oscillator A2.

In this fashion, when wireless communication is to be executed, the frequency circuit 14 selects a frequency which does not interfere with the wireless communication band used by the wireless communication unit 18 (wireless unit 18a), and the information processing apparatus (except for the wireless unit) is operated at the operation clock having the selected frequency. As a result, noise generated in wireless communication can be reduced to improve the wireless communication quality. When wireless communication is not performed, the information processing apparatus can be operated at an operation clock having a frequency for a predetermined purpose such that the CPU 10 is operated at high speed.

In the above description, the CPU 10 basically operates at the operation clock having frequency f1 of clock oscillator A1. In some cases, the CPU 10 is switched to the operation clock having frequency f2 of clock oscillator A2 in order to change to, e.g., a power saving operation mode during normal operation. In this case, if frequency f2 interferes with the wireless frequency used by the wireless communication unit 18 in an operation mode in which the CPU 10 operates at the operation clock having frequency f2 of clock oscillator A2 in normal operation, clock oscillator A2 is switched to clock oscillator A1, as described above.

In the above description, the operation clock of the CPU 10 is changed by the frequency circuit 14. The operation clock of a unit (peripheral circuit 16) of the information processing apparatus other than the CPU 10 is also changed.

The clock control operation of an information processing apparatus according to the second embodiment will be described.

In the first embodiment, when the frequency of the operation clock interferes with the wireless frequency used by the wireless communication unit 18, a frequency different from the current frequency generated by the frequency circuit 14 is selected to operate the information processing apparatus. In the second embodiment, the operation frequency is switched in accordance with a change in communication quality in wireless communication.

For example, when the BER (Bit Error Rate) value or FER (Frame Error Rate) value representing the wireless communication quality exhibits that the wireless communication quality is lower than a predetermined level, the operation frequency of a unit other than a wireless communication unit 18 may interfere with the wireless frequency. In this case, clock control of changing the operation frequency of the unit other than the wireless communication unit 18 is executed.

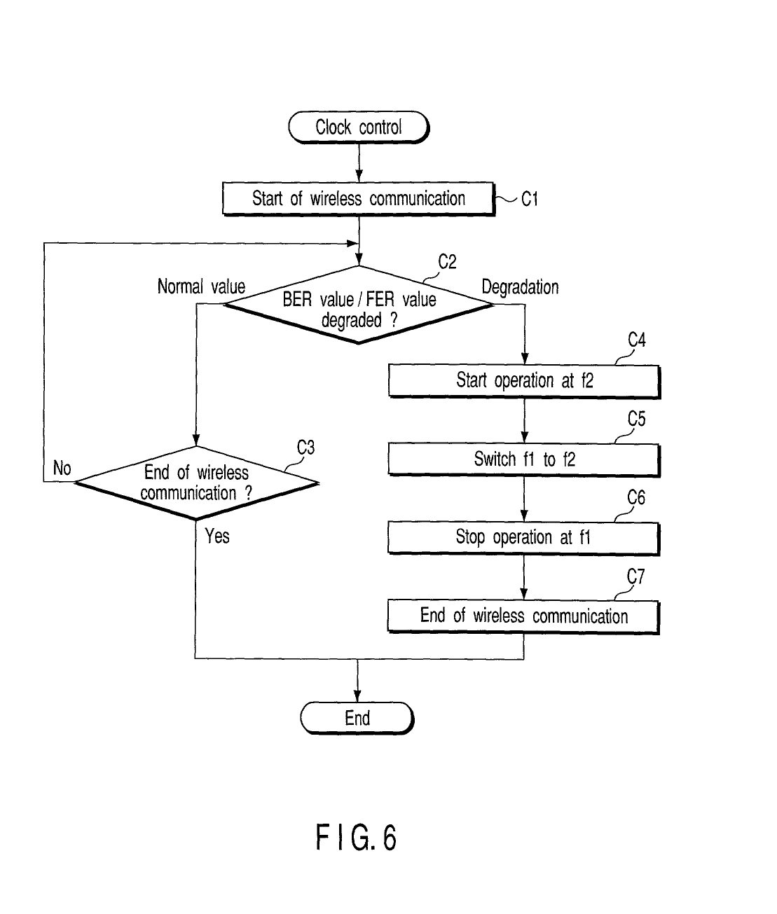

FIG. 6 is a flow chart showing clock control of the second embodiment.

After a CPU 10 starts wireless communication using the wireless communication unit 18 (step C1), it acquires a BER value or FER value representing the wireless communication quality from a wireless unit 18a. The CPU 10 checks whether this value is smaller than a predetermined value set in advance or the communication quality becomes lower than a predetermined level (step C2). Note that the predetermined value set in advance for the BER or FER value is determined in accordance with the communication quality level obtained when the operation frequency of a unit other than the wireless communication unit 18 interferes with the wireless frequency.

If the CPU 10 determines based on the BER or FER value that the communication quality is not lower than the predetermined level, it continuously executes wireless communication without changing the operation frequency of the unit other than the wireless communication unit 18 (step C3).

If the CPU 10 determines that the communication quality becomes lower than the predetermined level, it instructs a clock selection circuit 14a to change the clock oscillator. The CPU 10 causes the clock selection circuit 14a to select a clock oscillator A2 (steps C4 to C6). The clock selection circuit 14a which has received the instruction from the CPU 10 starts the operation of clock oscillator A2 at rest. The circuit 14a changes the frequency of a clock to be output to the CPU 10 from frequency f1 of clock oscillator A1 to frequency f2 of clock oscillator A2. Then, the circuit 14a stops the operation of clock oscillator A1.

The CPU 10 operates at the operation clock having the operation frequency switched by a frequency circuit 14 until the end of wireless communication (step C7).

In this way, the wireless communication quality is always monitored while wireless communication is executed. If the communication quality is determined to become lower than a predetermined level, it is determined that the wireless communication quality has degraded under the influence of the operation frequency of a unit other than the wireless communication unit 18. Thus, the frequency generated by the frequency circuit 14 is switched to a frequency different from the current one. The apparatus is operated at this frequency, thereby improving the wireless communication quality and communication performance.

The clock control operation of an information processing apparatus according to the third embodiment will be described.

In the second embodiment, the operation frequency is switched in accordance with a change in communication quality in wireless communication. In the third embodiment, the frequency of the operation clock is changed at the timing when the wireless frequency is changed. As the timing when the wireless frequency is changed, interference with the wireless frequency is checked when a wireless communication unit 18 receives an incoming call (receives a wireless communication execution request) from a communication partner (base station or the like). The frequency of the operation clock is changed in accordance with the result.

FIG. 7 is a flow chart showing clock control of the third embodiment.

FIG. 7 exemplifies a case wherein an incoming call is confirmed in normal operation in which a CPU 10 operates at the frequency f1 of a clock oscillator A1, and interference with the wireless frequency used by the wireless communication unit 18 is checked.

If the CPU 10 receives a wireless communication request via a wireless unit 18a and peripheral circuit 16 in normal operation (confirm an incoming call), i.e., wireless communication using a wireless module starts (step D1), the CPU 10 acquires a wireless frequency value which has been determined between the apparatus and the communication partner and is used for wireless communication, by a communication function realized by a program which controls the wireless unit 18a to execute communication operation (step D2).

The CPU 10 checks whether frequency f1 of clock oscillator A1 in operation interferes with the wireless frequency band used by the wireless unit 18a (step D3). The CPU 10 determines that frequency f1 interferes with the wireless frequency when the wireless frequency of the wireless unit 18a is a constant multiple of frequency f1 or around a constant multiple.

If the CPU 10 determines that frequency f1 does not interfere with the wireless frequency of the wireless unit 18a, it starts wireless communication without instructing a clock selection circuit 14a to change the clock oscillator. The CPU 10 does not change the operation clock until wireless communication ends.

If the CPU 10 determines that frequency f1 interferes with the wireless frequency of the wireless unit 18a (Yes in step D3), it instructs the clock selection circuit 14a to change the clock oscillator immediately before the start of communication operation. The CPU 10 causes the clock selection circuit 14a to select clock oscillator A2 (steps D4 to D6). The clock selection circuit 14a which has received the instruction from the CPU 10 starts the operation of clock oscillator A2 at rest. The circuit 14a changes the frequency of a clock to be output to the CPU 10 from frequency f1 of clock oscillator A1 to frequency f2 of clock oscillator A2. Then, the clock 10 selection circuit 14a stops the operation of clock oscillator A1.

In this manner, a frequency circuit 14 can select at the timing of an incoming call a frequency which does not interfere with the wireless frequency. The information processing apparatus (except for the wireless unit) can be operated at the operation clock having the selected frequency. From the start of wireless communication, the operation frequency of a unit other than the wireless communication unit 18 can be set to a value which does not interfere with wireless communication.

In the above description, interference with the operation frequency is checked when the information processing apparatus receives an incoming call from a communication partner (when wireless communication starts). To change another wireless frequency, for example, to dynamically change the wireless frequency during wireless communication, the same processing as that described above may be executed at the change timing.

At the timing when the wireless frequency is changed, the frequency circuit 14 selects a frequency which does not interfere with the wireless frequency. The information processing apparatus (except for the wireless unit) is operated at the operation clock having the selected frequency. This can reduce noise generated in wireless communication to improve the wireless communication quality.

The fourth embodiment will be explained.

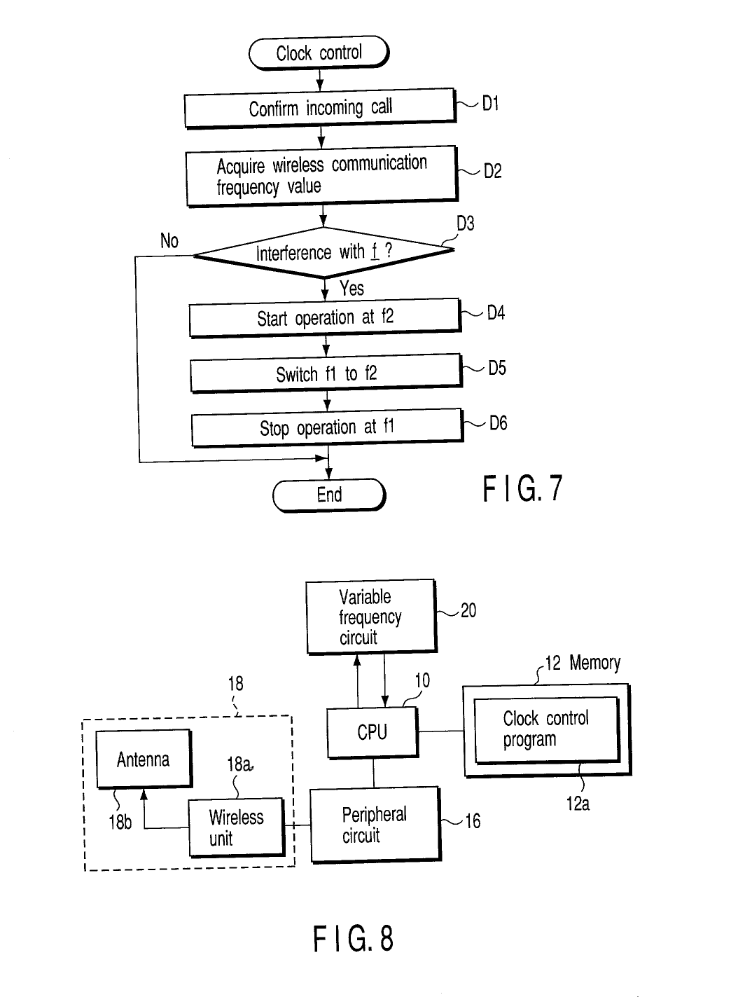

FIG. 8 is a block diagram showing the main arrangement of an information processing apparatus according to the fourth embodiment of the present invention. As shown in FIG. 8, the information processing apparatus in the fourth embodiment comprises a CPU 10, memory 12, peripheral circuit 16, and variable frequency circuit 20.

The information processing apparatus of the fourth embodiment does not adopt the frequency circuit 14 having two clock oscillators A1 and A2, unlike the information processing apparatuses of the first to third embodiments. Instead, a variable frequency circuit 20 using a PLL (Phase Locked Loop) or the like is arranged to change the frequency. The frequency changeable by the variable frequency circuit 20 includes a plurality of frequencies which are not constant-multiplied/divided frequencies of a frequency before change and are not constant multiples of each other.

The operation of the information processing apparatus (clock control program 12a) in the fourth embodiment is the same as any one of the first to third embodiments, and a detailed description thereof will be omitted. For example, degradation of the communication quality is detected, like the second embodiment. Alternatively, the wireless frequency used for wireless communication is determined before the start of wireless communication, and the operation frequency of the apparatus interferes with the wireless frequency, like the third embodiment. In either case, a frequency which does not interfere with the frequency used for wireless communication in a wireless communication unit 18 (wireless unit 18a and antenna 18b connected to the information processing apparatus is selected from the variable frequency circuit 20. The selected frequency is set for the operation clock of the CPU 10.

The use of the variable frequency circuit 20 capable of changing the oscillation frequency instead of generating a definite number of frequencies can flexibly change the operation frequency of the apparatus. The operation frequency of the apparatus can be flexibly changed in correspondence with a change in wireless communication quality or a difference in the wireless communication unit 18 (wireless frequency used for wireless communication), thus improving the wireless communication quality.

The fifth embodiment will be described.

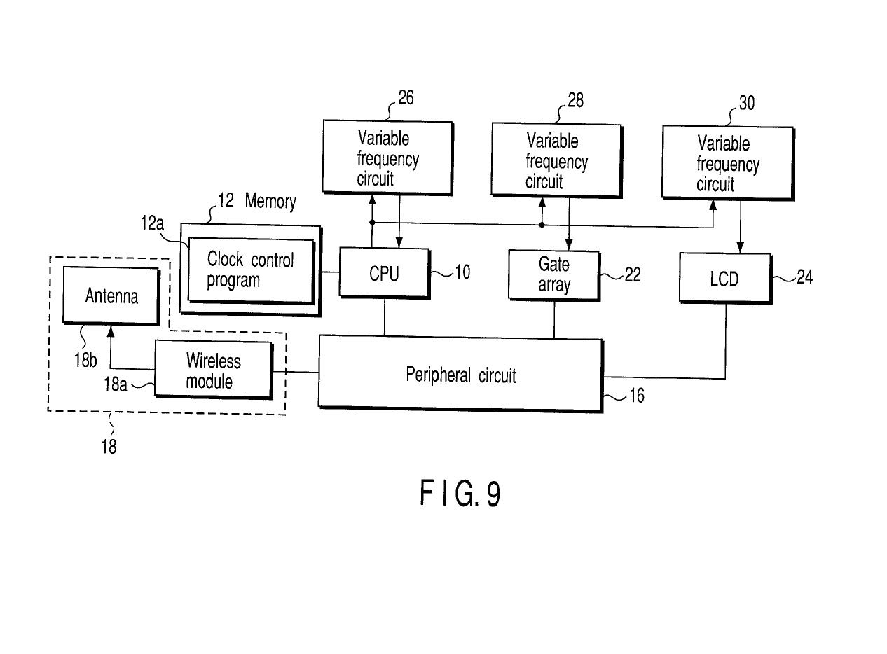

FIG. 9 is a block diagram showing the main arrangement of an information processing apparatus according to the fifth embodiment of the present invention. As shown in FIG. 9, the information processing apparatus in the fifth embodiment comprises a CPU 10, a memory 12, a peripheral circuit 16, chips or modules such as a gate array 22 and LCD 24, and clock control variable frequency circuits 26, 28, and 30 which respectively correspond to a plurality of units such as the CPU 10 and the chips or modules (gate array 22 and LCD 24) that operate at predetermined clocks. The variable frequency circuits 26, 28, and 30 are circuits for generating a CPU clock, gate array clock, and LCD clock, respectively. These circuits 26, 28, and 30 are controlled by a clock control program 12a under the control of the CPU 10. The circuits 26, 38, and 30 can generate a plurality of frequencies which are not constant multiplies of each other.

The operation of the information processing apparatus (clock control program 12a) in the fifth embodiment is the same as that in any one of the first to third embodiments, and a detailed description thereof will be omitted. For example, degradation of the communication quality is detected, like the second embodiment. Alternatively, the wireless frequency used for wireless communication is determined before the start of wireless communication, and the operation frequency of the apparatus interferes with the wireless frequency, like the third embodiment. In either case, the operation clock of the CPU 10 is individually set by the variable frequency circuit 26; that of the gate array 22, by the variable frequency circuit 28; and that of the LCD 24, by the variable frequency circuit 30.

In this way, the operation frequency can be individually changed in accordance with each unit which constitutes the apparatus. Each unit can be operated at an optimal operation frequency without adversely affecting the wireless frequency.

Note that the method described in each of the above-described embodiments can be written as a clock control program executable by a computer on a recording medium such as a magnetic disk (floppy disk, hard disk, or the like) and optical disk (CD-ROM, DVD, or the like), or in a semiconductor memory. This program-recorded medium can be provided to various apparatuses. Alternatively, the clock control program can be transmitted via a communication medium and provided to various apparatuses. The computer which implements the apparatus loads the clock control program recorded on the recording medium, or receives the clock control program via the communication medium. This program controls the operation of the computer to execute the above-described processing.

The present invention is not limited to the above-described embodiments, and can be variously modified without departing from the spirit and scope of the invention in practical use. The embodiments include inventions on various stages, and various inventions can be extracted by an appropriate combination of structural elements disclosed. For example, when an effect is obtained even by omitting several structural elements from all those described in the embodiments, the arrangement from which these structural elements are omitted can be extracted as an invention.

As has been described in detail above, according to the present invention, if the wireless communication quality degrades, or if the wireless frequency used for wireless communication is determined before the start of wireless communication, and the operation frequency of the apparatus interferes with the wireless frequency, the operation frequency of the information processing apparatus (apparatus side) is so changed as not to interfere with wireless communication. This can reduce noise in wireless communication to improve the communication quality.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus, comprising:
a wireless communication unit;
a frequency circuit which generates a plurality of frequencies that are not constant multiples to each other and serve as operation frequencies;
a communication quality determination unit which determines whether a communication quality of the wireless communication unit has become lower than a predetermined level; and
a selection unit which selects a frequency different from a current frequency from the plurality of frequencies generated by said frequency circuit when said communication quality determination unit determines that the communication quality has become lower than the predetermined level.

2. The apparatus according to claim 1, wherein
said frequency circuit includes a plurality of clock oscillators which generate the plurality of frequencies to operate at predetermined clocks, and
said selection unit selects the clock oscillator from the plurality of clock oscillators.

3. An information processing apparatus, comprising:
a wireless communication unit:
a frequency circuit which generates a plurality of frequencies that are not constant multiples of each other and serve as operation frequencies;
a determination unit which determines whether a wireless communication execution request exists;
a frequency determination unit which determines a wireless frequency to be used for the wireless communication unit when said determination unit determines that the wireless communication execution request exists;
an interference determination unit which determines whether a current operation frequency interferes with the wireless frequency determined by said frequency determination unit; and
a selection unit which selects a frequency which does not cause interference from the plurality of frequencies generated by said frequency circuit when said interference determination unit determines that the current operation frequency interferes with the wireless frequency

4. The apparatus according to claim 3, wherein
said frequency circuit includes a plurality of clock oscillators which generate the plurality of frequencies to operate at predetermined clocks, and
said selection unit selects the clock oscillator from the plurality of clock oscillators.

5. A clock control method for an information processing apparatus which performs wireless communication, comprising:
communication quality determining whether communication quality in wireless communication has become lower than a predetermined level;
selecting a frequency different from a current frequency from a frequency circuit which generates a plurality of frequencies that are not constant multiples of each other and serve as operation frequencies of the apparatus when the communication quality is determined in the communication quality determining to have become lower than the predetermined level; and
operating the apparatus on the basis of the frequency selected in the selecting a frequency.

6. A clock control method for an information processing apparatus which performs wireless communication, comprising:
determining whether a wireless communication execution request exists;
determining a wireless frequency used for wireless communication when presence of the wireless communication execution request is determined in the determining;
determining whether a current operation frequency of the apparatus interferes with the wireless frequency determined in the determining a wireless frequency; and
when the current operation frequency interferes with the wireless frequency, selecting a frequency of the clock which does not interfere with the wireless frequency determined in the determining a wireless frequency.
